(19) United States
(12) Patent Application Publication
(10) Pub. No.: US 2023/0288659 A1
(43) Pub. Date: Sep. 14, 2023

(54) STRUCTURE FOR A LENS HOLDER AND A METHOD THEREOF

(71) Applicant: E-CON SYSTEMS INDIA PRIVATE LIMITED, CHENNAI (IN)

(72) Inventor: SATHIYA NARAYANAN L, CHENNAI (IN)

(21) Appl. No.: 17/691,220

(22) Filed: Mar. 10, 2022

(51) Int. Cl. G02B 7/02

(52) U.S. Cl. CPC G02B 7/02

(57) ABSTRACT

A structure for a lens holder is disclosed. The structure includes a hollow segment which receives and holds a lens via a first end of the hollow segment which includes an outward projection situated laterally at a first location on the hollow segment, extended throughout a length of the hollow segment, and includes at least one first hole threaded internally. The at least one first hole receives a corresponding at least one first screw for affixing the lens to the hollow segment. The structure also includes at least two affixing segments attached to the hollow segment, situated at a corresponding at least two second locations, extended laterally outward from the hollow segment, and include corresponding second hole(s) threaded internally. The second hole(s) receive a corresponding at least one second screw for affixing the hollow segment to a component of a lens demanding device.

### FIELD OF INVENTION

Embodiments of the present disclosure relate to a field of the lens holding structures, and more particularly to, a structure for a lens holder and a method thereof.

### BACKGROUND

Lenses are used in various imaging devices like telescopes, binoculars, and cameras. Lens holders refer to a structure that is used to stabilize and maintain the position of all of the optical components in a lens assembly. The primary purpose of the lens holder is to provide stability and keep optical elements firmly in place. Also, the size of the lens holder varies based on application. Conventionally, a lens holder typically consists of a lens barrel, a base, and a mounting option attached to the base. The base is bigger than the lens barrel and may be larger than the image sensor that will be utilised, which will take up a significant amount of printed circuit board (PCB) space when mounted.

However, the larger size both in terms of floor space and head space are limiting factors to decide a minimum size of end products using the lens holder. Also, conventionally, a positioning of the lens holders on the PCB is such that, it occupies more surface area of the PCB, thereby further increasing the floor space.

Hence, there is a need for an improved structure for a lens holder and a method thereof which addresses the aforementioned issue(s).

### BRIEF DESCRIPTION

In accordance with an embodiment of the present disclosure, a structure for a lens holder is provided. The structure includes a hollow segment adapted to receive and hold a lens via a first end of the hollow segment. The hollow segment includes an outward projection. The outward projection is situated laterally at a first location on the hollow segment. The outward projection is extended throughout a length of the hollow segment. The outward projection includes at least one first hole. The at least one first hole is threaded internally. The at least one first hole is adapted to receive a corresponding at least one first screw for affixing the lens at a preferred position inside of the hollow segment using a predefined affixing mechanism, upon receiving the lens. The at least one first screw is received perpendicularly to a central axis of the hollow segment. The structure also includes at least two affixing segments attached to the hollow segment. The at least two affixing segments are situated in proximity to a second end of the hollow segment at a corresponding at least two second locations. The at least two affixing segments are extended laterally outward from the hollow segment. The at least two affixing segments include corresponding one or more second holes. The one or more second holes are threaded internally. The one or more second holes are adapted to receive a corresponding at least one second screw for affixing the hollow segment to a component of a lens demanding device using the predefined affixing mechanism. The at least one second screw is received parallelly to the central axis of the hollow segment.

In accordance with another embodiment of the present disclosure, a method for obtaining a structure for a lens holder is provided. The method includes providing a hollow segment, wherein the hollow segment is adapted for receiving and holding a lens via a first end of the hollow segment. The method further includes forming an outward projection on the hollow segment, wherein the outward projection is situated laterally at a first location on the hollow segment, and extended throughout a length of the hollow segment. The method further includes forming at least one first hole on the outward projection, wherein the at least one first hole is threaded internally, and adapted for receiving a corresponding at least one first screw for affixing the lens at a preferred position inside of the hollow segment using a predefined affixing mechanism, upon receiving the lens. The method further includes providing at least two affixing segments. The method further includes attaching the at least two affixing segments to the hollow segment, wherein the at least two affixing segments are situated in proximity to a second end of the hollow segment at a corresponding at least two second locations. The method further includes forming one or more second holes on the corresponding at least two affixing segments, wherein the one or more second holes is threaded internally, and adapted for receiving a corresponding at least one second screw for affixing the hollow segment to a component of a lens demanding device using the predefined affixing mechanism.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a schematic representation of an isometric view of a structure for a lens holder in accordance with an embodiment of the present disclosure;

FIG. 2 is a schematic representation of an embodiment of a cross-sectional view of the structure of FIG. 1 in accordance with an embodiment of the present disclosure;

FIG. 3 is a schematic representation of an embodiment of the structure FIG. 1 depicting a plurality of views of the structure in accordance with an embodiment of the present disclosure;

FIG. 3 (a) is a schematic representation of an embodiment of the structure FIG. 1 depicting a top view of the structure in accordance with an embodiment of the present disclosure;

FIG. 3 (b) is a schematic representation of an embodiment of the structure FIG. 1 depicting a bottom view of the structure in accordance with an embodiment of the present disclosure;

FIG. 3 (c) is a schematic representation of an embodiment of the structure FIG. 1 depicting a side view of the structure in accordance with an embodiment of the present disclosure; and

FIG. 4 illustrates a flow chart representing the steps involved in a method for obtaining a structure for a lens holder in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

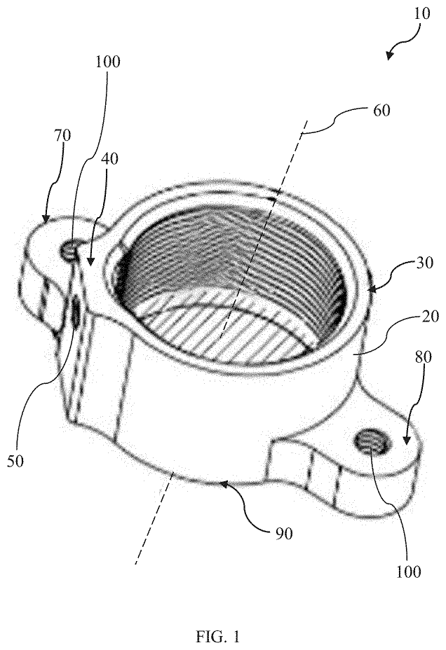

Embodiments of the present disclosure relate to a structure for a lens holder and a method thereof. Lenses are used in various imaging devices like telescopes, binoculars and cameras. As used herein, the term “lens holder” refers to a structure that is used to stabilize and maintain the position of all of the optical components in a lens assembly. The primary purpose of the lens holder is to provide stability and keep optical elements firmly in place. Also, a size of the lens holder varies based on application. Further, advancement in technology demands for miniaturization of the structure for the lens holder. Moreover, the structure described hereafter in FIG. 1 is the structure for the lens holder.

FIG. 1 is a schematic representation of an isometric view of a structure 10 for a lens holder in accordance with an embodiment of the present disclosure. The structure 10 includes a hollow segment 20 adapted to receive and hold a lens via a first end 30 of the hollow segment 20. In one embodiment, the hollow segment 20 may receive and hold a lens assembly including one or more lenses, wherein each of the one or more lenses may be having different purposes. The hollow segment 20 includes an outward projection 40. The outward projection 40 is situated laterally at a first location on the hollow segment 20. The outward projection 40 is extended throughout a length of the hollow segment 20. Also, in an embodiment, the hollow segment 20 may be cylindrical in shape having the outward projection 40 situated laterally on the hollow segment 20.

The outward projection 40 includes at least one first hole 50. The at least one first hole 50 is threaded internally. The at least one first hole 50 is adapted to receive a corresponding at least one first screw for affixing the lens at a preferred position inside of the hollow segment 20 using a predefined affixing mechanism, upon receiving the lens. The at least one first screw is received perpendicularly to a central axis 60 of the hollow segment 20.

In one exemplary embodiment, the at least one first screw may include a grub screw. As used herein, the term “grub screw” is defined as a small headless screw that is slotted at one end to receive a screwdriver and when placed in a continuous threaded hole between two adjacent pieces prevents lateral movement. Therefore, in an embodiment, the at least one first screw may be threaded on a first screw outer surface of the corresponding at least one first screw. As the at least one first hole 50 is threaded internally, the at least one first screw may easily fit into the corresponding at least one first hole 50 using the predefined affixing mechanism. In one embodiment, the predefined affixing mechanism may include a rotational mechanism. Therefore, the at least one first screw may be rotated in a predefined direction, by simultaneously applying pressure in a forward direction using a predefined tool, thereby enabling the corresponding at least one first screw to enter and fit into the corresponding at least one first hole 50 for affixing the lens. The predefined tool may include a screwdriver.

The structure 10 also includes at least two affixing segments 70, 80 attached to the hollow segment 20. The at least two affixing segments 70, 80 are situated in proximity to a second end 90 of the hollow segment 20 at a corresponding at least two second locations. The at least two second locations may be opposite to each other. The at least two affixing segments 70, 80 are extended laterally outward from the hollow segment 20. Also, in an embodiment, the at least two affixing segments 70, 80 may lie on a same linear plan.

The at least two affixing segments 70, 80 include corresponding one or more second holes 100. The one or more second holes 100 are threaded internally. The one or more second holes 100 are adapted to receive a corresponding at least one second screw for affixing the hollow segment 20 to a component of a lens demanding device using the predefined affixing mechanism. The at least one second screw is received parallelly to the central axis 60 of the hollow segment 20. In an embodiment, the at least one second screw may be threaded on a second screw outer surface of the corresponding at least one second screw. As the one or more second holes 100 are threaded internally, the at least one second screw may easily fit into the corresponding one or more second holes 100 using the predefined affixing mechanism.

Further, the at least one second screw may be rotated in a predefined direction, by simultaneously applying pressure in a forward direction using the predefined tool, thereby enabling the corresponding at least one second screw to entire and fit into the corresponding one or more second holes 100 for affixing the hollow segment 20 to the component of the lens demanding device.

In one exemplary embodiment, the lens demanding device may include an embedded camera module. The component may include a printed circuit board (PCB). As used herein the term “embedded camera module” is defined as a camera module integrated with a processing board. As used herein the term “camera module” refers to an image sensor integrated with a lens, control electronics, and an interface like CSI, Ethernet, or plain raw low-voltage differential signaling. In such embodiment, the hollow segment 20 may be affixed to the PCB by positioning the at least two affixing segments 70, 80 in proximity to one or more corners of the PCB.

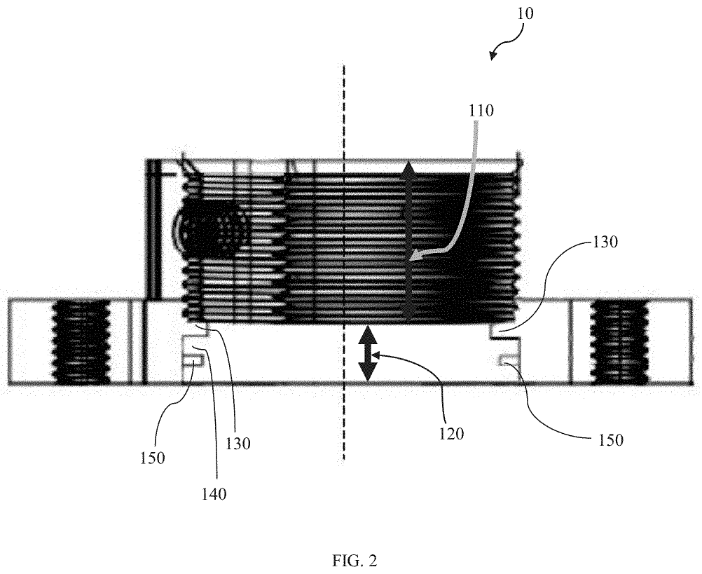

FIG. 2 is a schematic representation of an embodiment of a cross-sectional view of the structure 10 of FIG. 1 in accordance with an embodiment of the present disclosure. Further, in one exemplary embodiment, the hollow segment 20 may include a first portion 110 extended to a first predefined length of the hollow segment 20. The first portion 110 may be threaded internally starting from the first end 30 of the hollow segment 20. Similarly, in an embodiment, the hollow segment 20 may include a second portion 120 adjacent to the first portion 110. The second portion 120 may be extended to a second predefined length of the hollow segment 20.

Moreover, in an embodiment, the first portion 110 may be extended to a greater extent in comparison to the second portion 120. In addition, the second portion 120 may include an annular flange 130. The annular flange 130 may be extended radially inward from the second portion 120. The annular flange 130 may be adapted to block a further movement of the lens when the lens is received via the first end 30 of the hollow segment 20.

Subsequently, in an embodiment, the second portion 120 may include a filter space 140 adjacent to the annular flange 130. The filter space 140 may be adapted to receive and hold one or more filters via the second end 90 of the hollow segment 20. In one exemplary embodiment, the one or more filters may include at least one of a haze filter, a polarizing filter, an infrared (IR) filter, and the like. Further, the second portion 120 may include a filter lock 150 adapted to lock the one or more filters inside the filter space 140. In one embodiment, the filter lock 150 may be composed of rubber, nylon, or the like. The filter lock 150 may lock the one or more filters inside the filter space 140 upon pushing the corresponding one or more filters from the second end 90 of the hollow segment 20.

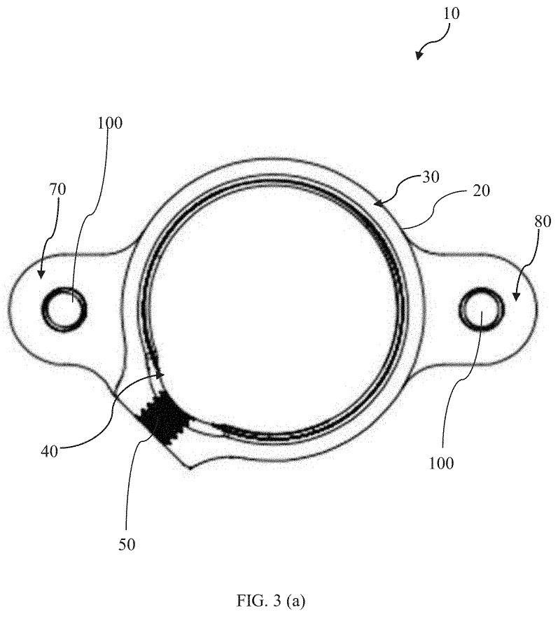

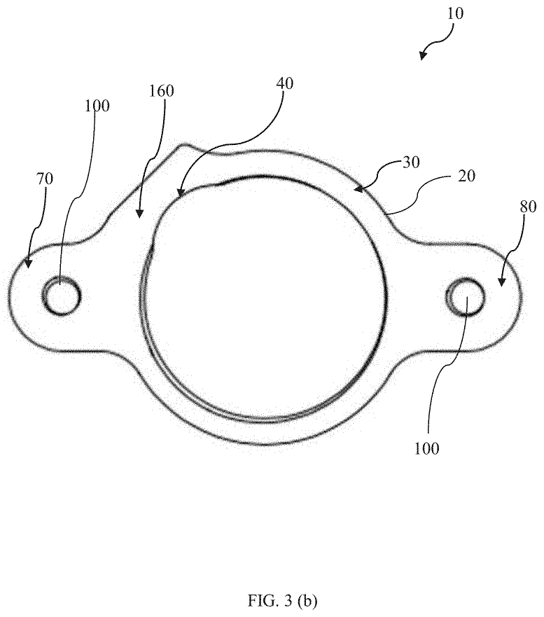

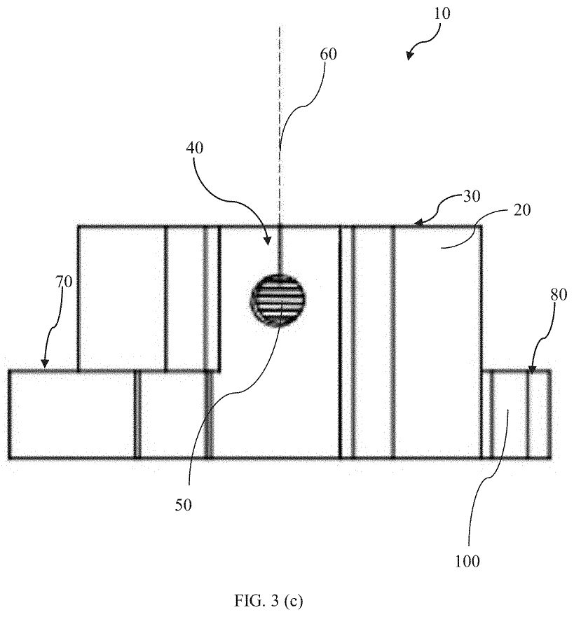

FIG. 3 is a schematic representation of an embodiment of the structure 10 FIG. 1 depicting a plurality of views of the structure 10 in accordance with an embodiment of the present disclosure. FIG. 3 (a) is a schematic representation of an embodiment of the structure 10 FIG. 1 depicting a top view of the structure 10 in accordance with an embodiment of the present disclosure. FIG. 3 (b) is a schematic representation of an embodiment of the structure 10 FIG. 1 depicting a bottom view of the structure 10 in accordance with an embodiment of the present disclosure. FIG. 3 (c) is a schematic representation of an embodiment of the structure 10 FIG. 1 depicting a side view of the structure 10 in accordance with an embodiment of the present disclosure. Basically, in an embodiment, the hollow segment 20 may appear circular in shape in the top view with a shape of the outward projection 40 being associated with the circular shape. Therefore, in an embodiment, an inner radius of the hollow segment 20 may include about 12 millimeters (mm). Further, an outer radius of the hollow segment 20 may be about 14 mm. Furthermore, a width of the outward projection 40 may be about 4.09 centimeter (cm) to about 4.29 cm. Similarly, a thickness of the outward projection 40 may be about 3 mm. Further, in an embodiment, a body of the structure 10 may be composed of predefined material, wherein the predefined material may include plastic, metal, or the like. In case of Aluminium like metals, a surface finishing used may be anodizing which prevents electrical continuity. In an embodiment the surface finishing may be used at a bottom surface 160 of the structure 10 as shown in FIG. 3 (b). Further, to allow electrical continuity, the surface finishing at the bottom surface 160 of the structure 10 may be void, so that the bottom surface 160 of the structure 10 may get electrically connected to a PCB ground. Moreover, a diameter of the at least one first hole 50 and the one or more second holes 100 may be about 2 mm.

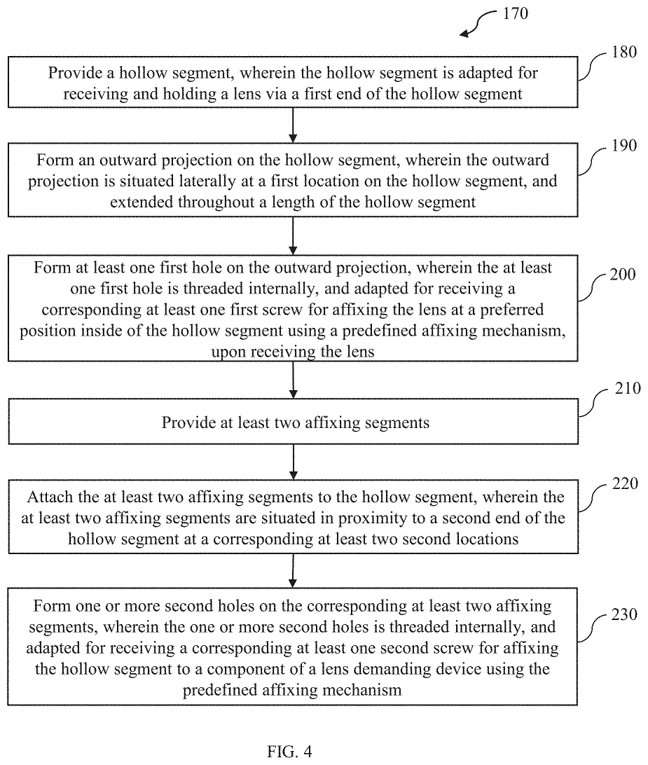

FIG. 4 illustrates a flow chart representing the steps involved in a method 170 for obtaining a structure for a lens holder in accordance with an embodiment of the present disclosure. The method 170 includes providing a hollow segment, wherein the hollow segment is adapted for receiving and holding a lens via a first end of the hollow segment in step 180.

The method 170 further includes forming an outward projection on the hollow segment, wherein the outward projection is situated laterally at a first location on the hollow segment, and extended throughout a length of the hollow segment in step 190.

The method 170 further includes forming at least one first hole on the outward projection, wherein the at least one first hole is threaded internally, and adapted for receiving a corresponding at least one first screw for affixing the lens at a preferred position inside of the hollow segment using a predefined affixing mechanism, upon receiving the lens in step 200.

In one embodiment, receiving the corresponding at least one first screw may include receiving the corresponding at least one first screw perpendicularly to a central axis of the hollow segment. Further, in one exemplary embodiment, affixing the lens at the preferred position inside of the hollow segment using the predefined affixing mechanism may include affixing the lens at the preferred position inside of the hollow segment using the rotational mechanism.

The method 170 further includes providing at least two affixing segments in step 210. In one embodiment, providing the at least two affixing segments may include providing the at least two affixing segments, wherein the at least two affixing segments are extended laterally outward from the hollow segment.

The method 170 further includes attaching the at least two affixing segments to the hollow segment, wherein the at least two affixing segments are situated in proximity to a second end of the hollow segment at a corresponding at least two second locations in step 220.

The method 170 further includes forming one or more second holes on the corresponding at least two affixing segments, wherein the one or more second holes is threaded internally, and adapted for receiving a corresponding at least one second screw for affixing the hollow segment to a component of a lens demanding device using the predefined affixing mechanism in step 230. In one embodiment, receiving the corresponding at least one second screw may include receiving the corresponding at least one second parallelly to a central axis of the hollow segment.

In one exemplary embodiment, the method 170 may further include extending a first portion of the hollow segment to a first predefined length of the hollow segment, wherein the first portion is threaded internally starting from the first end of the hollow segment.

Further, in one embodiment, the method 170 may also include extending a second portion of the hollow segment to a second predefined length of the hollow segment, wherein the second portion of the hollow segment is adjacent to the first portion of the hollow segment.

Furthermore, the method 170 may also include forming an annular flange, wherein the annular flange is extended radially inward from the second portion, wherein the annular flange is adapted for blocking further movement of the lens when the lens is received via the first end of the hollow segment.

Moreover, the method 170 may further include providing a filter space adjacent to the annular flange, wherein the filter space is adapted for receiving and holding one or more filters via the second end of the hollow segment.

The method 170 may further include providing a filter lock for locking the one or more filters inside the filter space using a predefined locking mechanism, upon receiving the corresponding one or more filters.

Various embodiments of the present disclosure, enable reducing the size of end products which are using lens holders as the lens holders are miniaturized b the reduction of floor space and headspace of the lens holders. Basically, reduced space is consumed on the PCB by placing the lens holders diagonally on the PCB. Further, the presence of the outward projection for receiving a screw which may be a grub screw, makes the structure more efficient as the lens is held firmly with the help of the screw.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing subsystem” may generally refer to any of the foregoing logic circuitry, alone or in combination with other logic circuitry, or any other equivalent circuitry A control unit including hardware may also perform one or more of the techniques of this disclosure.

Such hardware, software, and firmware may be implemented within the same device or within separate devices to support the various techniques described in this disclosure. In addition, any of the described units, modules, or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A structure for a lens holder comprising:
a hollow segment adapted to receive and hold a lens via a first end of the hollow segment, wherein the hollow segment comprises:
an outward projection situated laterally at a first location on the hollow segment, and extended throughout a length of the hollow segment, wherein the outward projection comprises at least one first hole,
wherein the at least one first hole is threaded internally, and adapted to receive a corresponding at least one first screw for affixing the lens at a preferred position inside of the hollow segment using a predefined affixing mechanism, upon receiving the lens,
wherein the at least one first screw is received perpendicularly to a central axis of the hollow segment; and
at least two affixing segments attached to the hollow segment, and situated in proximity to a second end of the hollow segment at a corresponding at least two second locations,
wherein the at least two affixing segments are extended laterally outward from the hollow segment,
wherein the at least two affixing segments comprises corresponding one or more second holes,
wherein the one or more second holes are threaded internally, and adapted to receive a corresponding at least one second screw for affixing the hollow segment to a component of a lens demanding device using the predefined affixing mechanism,
wherein the at least one second screw is received parallelly to the central axis of the hollow segment.

2. The structure of claim 1, wherein the at least one first screw comprises a grub screw.

3. The structure of claim 1, wherein the predefined affixing mechanism comprises a rotational mechanism.

4. The structure of claim 1, wherein the lens demanding device comprises an embedded camera module, wherein the component comprises a printed circuit board.

5. The structure of claim 4, wherein the hollow segment is affixed to the printed circuit board by positioning the at least two affixing segments in proximity to one or more corners of the printed circuit board.

6. The structure of claim 1, wherein the hollow segment comprises a first portion extended to a first predefined length of the hollow segment, wherein the first portion is threaded internally starting from the first end of the hollow segment.

7. The structure of claim 6, wherein the hollow segment comprises a second portion adjacent to the first portion, wherein the second portion is extended to a second predefined length of the hollow segment.

8. The structure of claim 7, wherein the second portion comprises an annular flange extended radially inward from the second portion, wherein the annular flange is adapted to block further movement of the lens when the lens is received via the first end of the hollow segment.

9. The structure of claim 8, wherein the second portion comprises a filter space adjacent to the annular flange, wherein the filter space is adapted to receive and hold one or more filters via the second end of the hollow segment.

10. The structure of claim 9, wherein the second portion comprises a filter lock adapted to lock the one or more filters inside the filter space using a predefined locking mechanism, upon receiving the corresponding one or more filters.

11. A method for obtaining a structure for a lens holder, wherein the method comprises:
providing a hollow segment, wherein the hollow segment is adapted for receiving and holding a lens via a first end of the hollow segment;
forming an outward projection on the hollow segment, wherein the outward projection is situated laterally at a first location on the hollow segment, and extended throughout a length of the hollow segment;
forming at least one first hole on the outward projection, wherein the at least one first hole is threaded internally, and adapted for receiving a corresponding at least one first screw for affixing the lens at a preferred position inside of the hollow segment using a predefined affixing mechanism, upon receiving the lens;
providing at least two affixing segments;
attaching the at least two affixing segments to the hollow segment, wherein the at least two affixing segments are situated in proximity to a second end of the hollow segment at a corresponding at least two second locations; and
forming one or more second holes on the corresponding at least two affixing segments, wherein the one or more second holes is threaded internally, and adapted for receiving a corresponding at least one second screw for affixing the hollow segment to a component of a lens demanding device using the predefined affixing mechanism.

12. The method of claim 11, wherein receiving the corresponding at least one first screw comprises receiving the corresponding at least one first screw perpendicularly to a central axis of the hollow segment.

13. The method of claim 11, wherein affixing the lens at the preferred position inside of the hollow segment using the predefined affixing mechanism comprises affixing the lens at the preferred position inside of the hollow segment using the rotational mechanism.

14. The method of claim 11, wherein providing the at least two affixing segments comprises providing the at least two affixing segments, wherein the at least two affixing segments are extended laterally outward from the hollow segment.

15. The method of claim 11, wherein receiving the corresponding at least one second screw comprises receiving the corresponding at least one second parallelly to a central axis of the hollow segment.

16. The method of claim 11, comprising extending a first portion of the hollow segment to a first predefined length of the hollow segment, wherein the first portion is threaded internally starting from the first end of the hollow segment.

17. The method of claim 16, comprising extending a second portion of the hollow segment to a second predefined length of the hollow segment, wherein the second portion of the hollow segment is adjacent to the first portion of the hollow segment.

18. The method of claim 17, comprising forming an annular flange, wherein the annular flange is extended radially inward from the second portion, wherein the annular flange is adapted for blocking further movement of the lens when the lens is received via the first end of the hollow segment.

19. The method of claim 18, comprising providing a filter space adjacent to the annular flange, wherein the filter space is adapted for receiving and holding one or more filters via the second end of the hollow segment.

20. The method of claim 19, comprising providing a filter lock for locking the one or more filters inside the filter space using a predefined locking mechanism, upon receiving the corresponding one or more filters.
